(19) United States
(12) Patent Application Publication
(10) Pub. No.: US 2005/0242565 A1
(43) Pub. Date: Nov. 3, 2005

(54) Folder for temporarily binding a small stack of sheets

(75) Inventors: Steve Beno, Gurnee, IL (US); Seesong Kang, Northbrook, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Northbrook, IL (US)

(21) Appl. No.: 11/106,924

(22) Filed: Apr. 15, 2005

Related U.S. Application Data
(60) Provisional application No. 60/567,690, filed on May 3, 2004.

(51) Int. Cl. B42D 3/00

(52) U.S. Cl. 281/29

(57) ABSTRACT

A folder, comprising two sheets of plastic joined along an elongated length by a securement, retains a small stack of sheets inserted therein without the need for additional binding mean, retaining force, or an additional sealed edge or auxiliary maintaining surface. The stack of sheets is easily inserted and removed from the folder because three of the four edges of the folder are unsealed. When the stack of sheets is inserted into the folder, so that a securing edge of the stack is disposed proximal to the securement of the folder, the stack is retained in place, due to the force produced by the firmness of the sheets coupled with the tightness of the securement.

### FIELD OF THE INVENTION

The present invention relates generally to folders for holding one or more sheets of paper, and more particularly to a folder for temporarily securing a small stack of sheets inserted therein.

### BACKGROUND OF THE INVENTION

Many arrangements have been designed for containing, protecting and displaying inserted documents. There are more permanent types of binding arrangements such as book binding, hot nail bind arrangements such as in VELOBIND®, which is marketed by the assignee of this application, comb-type binding, twin loop binding and spiral coil binding. Unfortunately, however, sheets bound in these manners are not readily separated for modification, for supplementation, or for use of individual sheets. Moreover, such bindings generally require the sheets to include perforations along one edge to accommodate the binding element attachment. Further, such binding elements are not typically suited for or desirable for use in binding relatively small stacks of sheets. Accordingly, folders, sheet covers and documents protectors are often used with such relatively small stack of sheets. In its most rudimentary form, a folder comprises a rectangular sheet of paper or plastic material folded to form two sheets having a common folded edge, with the remaining three edges of each sheet unbound to one another. Paper sheets are inserted between the two sheets of the folder. Because the folder is entirely open on three of its sides, it can conveniently be opened fully by the user. However, such a folder includes no mechanism for securing the inserted paper sheets. Unless the user of the folder applies sufficient pressure when holding the folder, the inserted paper sheets will readily separate from the folder. Thus, such rudimentary folders are typically not sufficiently rigid to display the enclosed documents in a relatively vertical position while retaining the documents.

Improvements in the art have addressed the problem of keeping inserted paper sheets securely within the folder. In general, two approaches have been taken. In one approach, additional, relatively easily separable binding means are employed. References that describe this approach include U.S. Pat. No. 4,486,032 to Leahy, U.S. Pat. No. 4,575,123 to Giblin et al., and U.S. Pat. No. 5,947,524 to Podosek. For example, in one technique the common folded edge of the folder is inserted through a narrow opening in a plastic or metal binder spine. The binder spine ideally holds together the folder sheets and the paper sheets contained within the folder. Removal and reinsertion of sheets into the binder is highly inconvenient however, in as much as the binder spine must be removed, the stack reset with the cover sheets, and the binder spine replaced alone one edge. Thus, although the arrangement may be convenient for immediate removal of the sheets for use, reinsertion of the sheets into the folder is cumbersome and time consuming. Moreover, the utilization of folders including multiple parts can be relatively expensive in that it requires the manufacture, storage and manipulation of multiple components.

Other techniques involving an auxiliary binding element, such as clips or fasteners, may require the text of the inserted pages to be located at a distance from the closed edge of the folder, either reducing the available display surface of the sheets, or necessitating an increase in the size of the sheets in order to accommodate desired text arrangements. The use of fasteners also makes it more difficult and time-consuming for the folder user to insert and remove sheets. Further, certain kinds of paper documents may not have sufficient margin space to provide holes or the like for the passage of fasteners, such as binding tacks. Making holes in the paper sheets may also be aesthetically undesirable, and sheets bound by fasteners may tear during the course of normal handling.

The second approach involves sealing one or more additional edges of the folder. The techniques described in U.S. Pat. No. 5,335,027 to Lin et al., U.S. Pat. No. 5,806,894 to Dottel, U.S. Pat. No. 6,012,866 to Podosek, U.S. Pat. No. 6,019,539 and 6,183,158 to Lynton, U.S. Pat. No. 6,196,750 to Hansen, and U.S. Pat. No. 6,241,286 to Ogura et al., are illustrative. For example, a folder may have an upper opening and be closed on its three other edges. While such an arrangement clearly retains the enclosed documents securely, one drawback is that the sheets can be relatively difficult to insert into or remove from the confined pocket. Alternatively, the folder may be closed on two edges and open on the two remaining edges. Insertion of paper is easier in this case, but the efficacy of the folder in retaining the paper is reduced. The cited references provide incremental improvements aimed at addressing these problems, but none of them offers a solution that allows a folder to be open along three of its edges.

### SUMMARY OF THE INVENTION

In accordance with embodiments of the present invention, there is provided a folder for temporarily binding a small stack of sheets. The folder comprises two sheets or a single folded sheet resilient, relatively rigid plastic joined together along one edge by way of a securement, such as a weld. A small stack of sheets may be inserted into the folder between the joined plastic sheets that comprise the folder such that one edge of the stack is disposed proximal to the securement. The folder cover sheets are of such a material and firmness and the securement is of sufficient tightness that the cover sheets of the folder assert a holding force on the inserted stack of sheets such that the sheets are held in place within the folder without the need for an external force, auxiliary binding mechanism or additional sealed folder edge to retain the sheets. Because the folder includes a securement only along one edge, however, the inserted stack of sheets may be easily removed from and reinserted into the folder. Further, the resilient, relatively rigid nature of the plastic folder allows the user to maintain the folder in a relatively vertical position without releasing the documents contained therein. Additionally, when the folder is formed of a transparent or translucent plastic, the contents may be viewed through the folder for east in use.

Thus, the inventive design of the present invention is an improvement over the prior art, combining advantages previously associated with incompatible approaches to the design of folders and other document protection devices. These and other features of the present invention, as well as additional inventive features, will be apparent from the description of the invention provided herein.

### BRIEF DESCRIPTION OF THE DRAWINGS

FIG. 1 is a front perspective view of a folder constructed in accordance with an embodiment of the invention.

FIG. 2 is a front elevational view of the folder of FIG. 1.

FIG. 3A is a perspective view of the folder of FIG. 1, showing the folder in an opened position and sheets partially inserted therein.

FIG. 3B is a perspective view of the folder of FIG. 1, showing the folder in an opened position and the sheets fully inserted therein.

FIG. 3C is a perspective view of the folder of FIG. 1, showing the folder in a closed position and the sheets fully inserted therein.

FIG. 3D is a perspective view of the folder of FIG. 1, showing the folder in a closed position with the sheets fully inserted therein and the locking tab in position below the sheets.

FIG. 4A is a bottom side view of the folder of FIG. 1, prior to insertion of a stack of sheets.

FIG. 4B is a bottom side view of the folder of FIG. 1, with the stack of sheets fully inserted.

FIG. 4C is a fragmentary view of the folder of FIG. 4B, extending rightward from the open right edges of the folder cover sheets.

FIG. 4D is a fragmentary, cross-sectional view of the folder of FIG. 4B, extending leftward from the sealed left edges of the folder cover sheets.

FIG. 4E is the fragmentary, cross-sectional view of FIG. 4D wherein the locking tab is located in the locking position.

### DETAILED DESCRIPTION OF THE INVENTION

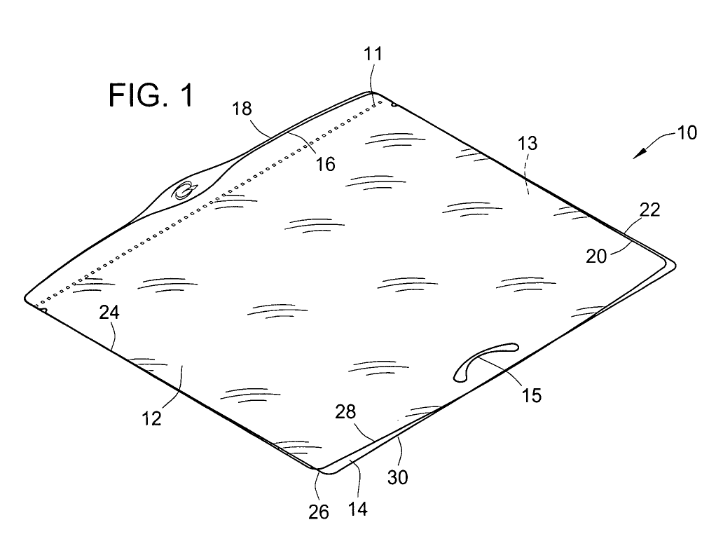

Turning now to the drawings, there is shown in FIG. 1 a folder 10 constructed in accordance with teachings of the present invention. It will be appreciated that the embodiment shown in FIG. 1 and the other drawings is not exclusive, and that alternate designs of folders, covers, and document protection and retention devices are embraced by the teachings of the invention.

The folder 10 depicted in FIG. 1 includes a front cover 12 and a back cover 14. The front and back covers 12, 14 are connected along a length 11 in order to form a pocket 13 for receiving a stack of sheets. The dimensions of the covers 12, 14 and the subsequent size of the pocket 13 are preferably sufficient to allow sheets of a desired size to be covered fully when completely inserted into the pocket 13 within the folder 10.

In accordance with the invention, the front and back covers 12, 14 are formed of a resilient, relatively rigid plastic and are secured along the length 11 such that the combination of the type of material and securement (see 11) provide and arrangement wherein a small stack of sheets contained within the pocket 13 with an edge of the stack proximal to the securement 11 is held within the folder 10. In the embodiment of FIG. 1, the securement 11 is provided proximal to the left edge 16, 18 of the front and back covers 12, 14, respectively, although the securement may be spaced away from the edge. For example, the securement 11 may extend substantially down the center of the front and back covers such that a pair of pockets is formed, one on either side of the securement. Regardless of the arrangement, however, significantly, the remaining edges of the folder 10 defining the pocket 13, here, the top edges 20, 22, bottom edges 24, 26, and right edges 28, 30 of the front and back covers 12, 14, respectively, are unsealed. Thus, the holding or retaining force on a stack of sheets contained within the pocket 13 is exerted only along one side of the stack of sheets is sufficient to retain the stack of sheets contained therein.

The securement 11 sealing the sheets 12, 14 together is achieved using a suitable means that provides a very tight retaining force in connection with the material utilized in the front and back covers 12, 14. Exemplary types of securements are sonic welding, heat sealing, heat welding, heat staking, or adhesive bonding by way of a glue or double-sided tape, although alternate securements may likewise be appropriate.

The front cover 12 and back cover 14 comprise sheets formed of an appropriate material so long as the area of the folder adjacent the securement 11 is resilient upon flexure, and is relatively rigid. Appropriate plastic materials, for example, include linear polyethylene, polypropylene, polystyrene, polyethylene terephthalate (polyester), polyvinyl chloride, polycarbonate, ABS, so long as the desired properties are provided. Further, while the folder 10 has been illustrated as including two separate front and back sheets, it will be appreciated that a single sheet that is folded along one edge may be utilized, for example, so long as the securement 11 is provided that, in combination with the material of the folder, asserts adequate holding force to retain the stack of sheets.

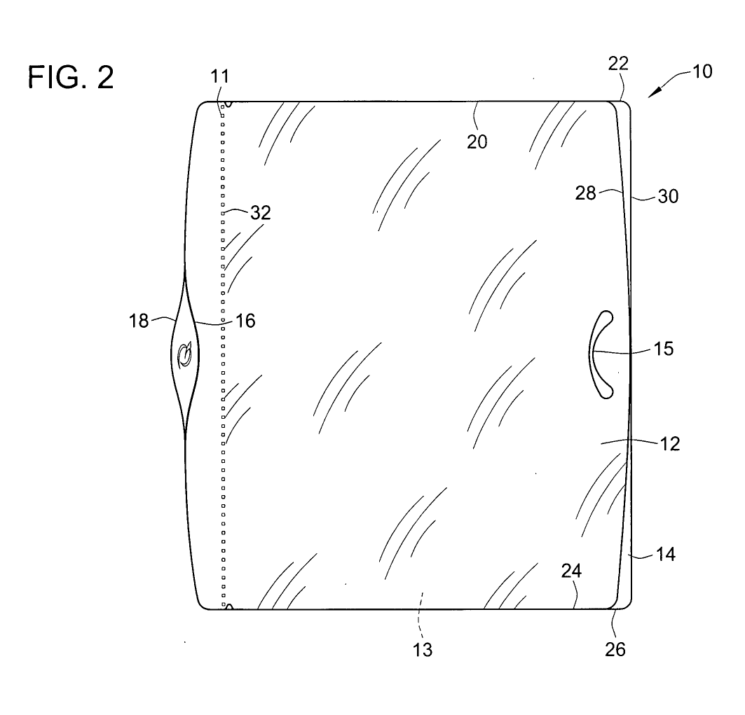

The folder 10 may include additional useful and ornamental features. A top view of the embodiment of the invention shown in FIG. 1 is provided in FIG. 2. Here the ornamental demarcation of the securement joining edges 16 and 18 is visible.

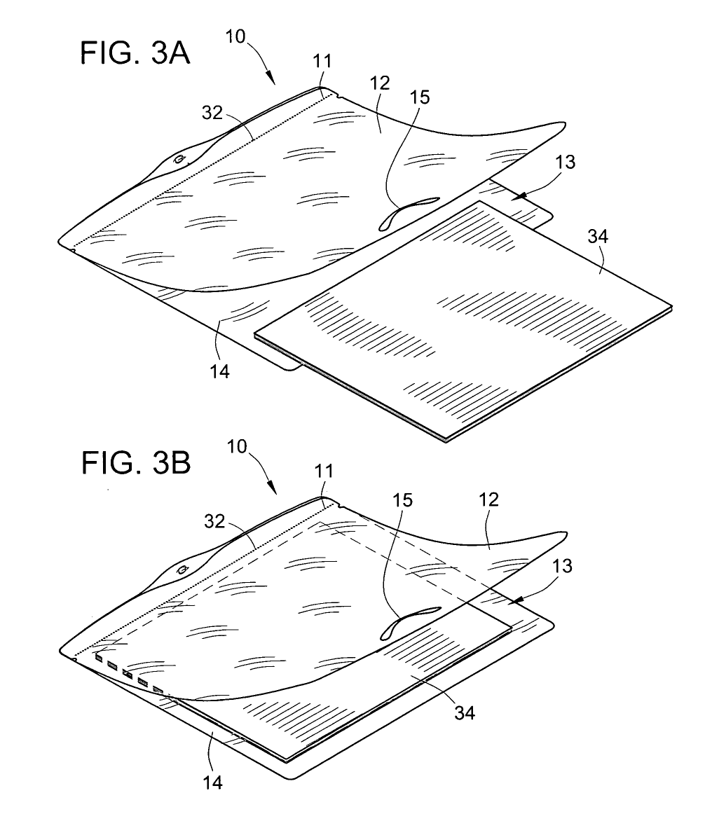

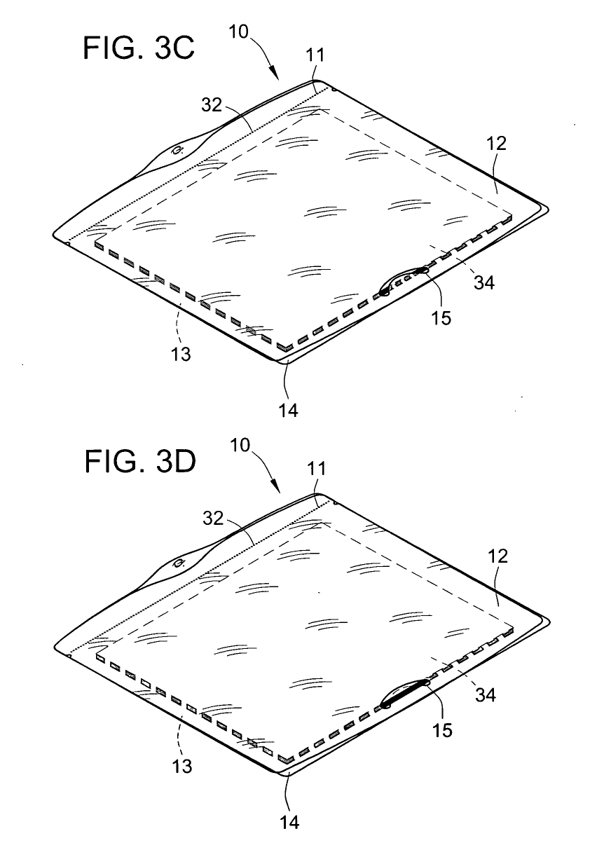

FIGS. 3A, 3B and 3C present the manner in which a folder 10 constructed in accordance with the invention may be opened and a stack of one or more sheets 34 inserted therein. As shown in FIGS. 3A and 3B, one or more sheets of 34 can easily be inserted into and removed from the folder 10 because the edges of the cover sheets 12, 14 are sealed together on only one side, here, the left side of the folder 10. In contrast, as noted above in the background section, folders and covers in the prior art which do not employ an auxiliary binding mechanism have required at least one additional folder edge to be sealed, a relatively cumbersome solution in which insertion and removal of sheets is more difficult.

As illustrated in FIGS. 3B and 3C, the small stack of one or more sheets of 34 may be inserted such that the left edges of the stack sheets 34 are disposed proximal to the securement edge 32 of the assembled folder 10. The degree of firmness of the plastic sheets 12, 14 of the folder 10, coupled with the degree of tightness of the securement binding the sheets 12, 14 together, produces adequate force to hold the inserted sheets 34 within the folder 10 without the need for an additional sealed edge to retain the sheets 34, an additional holding surface, or an additional binding mechanism.

While not necessary to the invention, in order to further retain a stack of sheets held within the folder 10, the folder 10 may be provided with a locking tab 15. When the folder 10 contains the stack of sheets 34 in a relatively permanent position, when being stored, for example, the locking tab 15 may be disposed below the stack of sheets 34 as shown in FIG. 3D. Thus, the edges 28, 30 of the folder are still separate from one another when the locking tab 15 is so placed. It will be appreciated by those of skill in the art that the locking tab 15 is of such a relatively small size and shape that it does not interfere with the ease of use of the folder 10 itself, as described above.

In one embodiment of the present invention, the plastic sheets 12, 14 comprising the covers of the folder 10 are substantially transparent or translucent, permitting an inserted and retained document to be readily displayed and viewed. Since no further holding surface is needed to retain the inserted sheets 34, the visual distortion such a surface may cause is avoided.

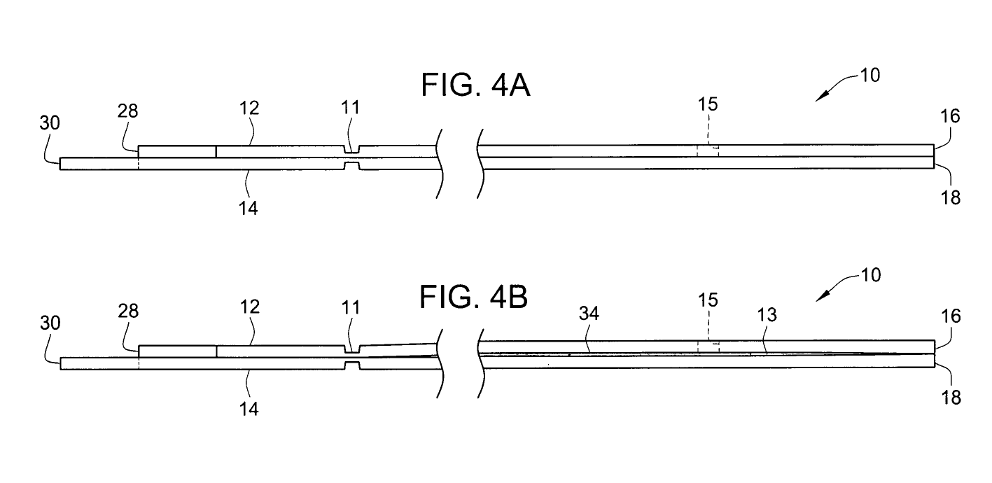

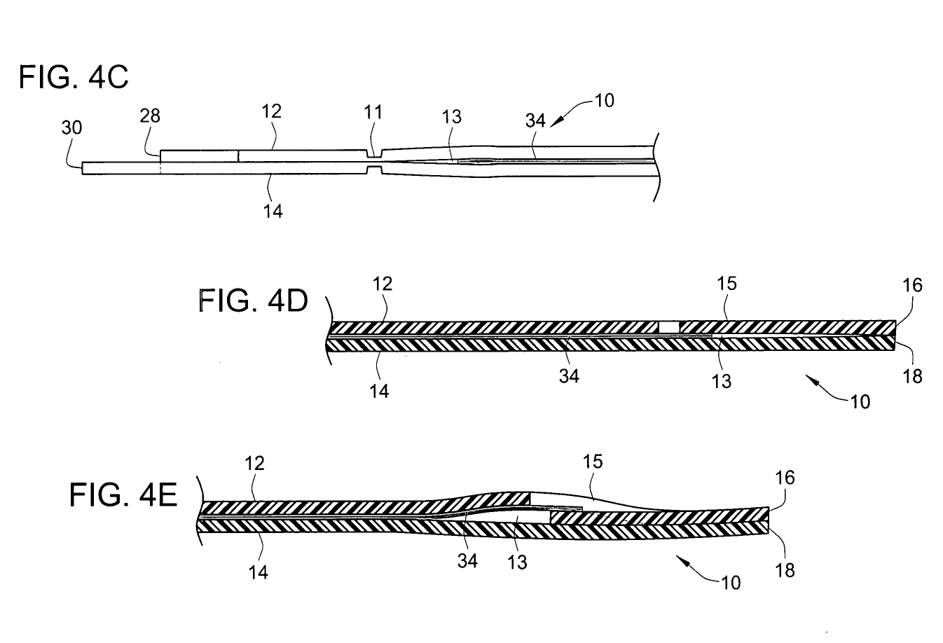

FIGS. 4A-4E show a bottom or cross-sectional views of the folder 10. FIG. 4A provides a view of the folder 10 prior to insertion of sheets. FIG. 4B presents the same view following the full insertion of the stack 34. FIGS. 4C and 4D provide expanded partial views of the view shown in FIG. 4B. As may be best seen in FIG. 4C, the stack of sheets 34 is proximal to, but is spaced away from the securement 11. The fragmentary, cross-sectional views of FIGS. 4D and 4E show the open edges of the folder 10 with the stack of sheets 34 place therebetween. In use, the locking tab 15 need not be utilized (as shown in FIG. 4C) or it may be disposed about the stack of sheets 34 to provide further retaining force (as shown in FIG. 4D).

It will be appreciated by those of skill in the art that, based on the particular firmness of the folder cover sheets and the particular tightness of the securement joining the cover sheets, there is a limit on the thickness of an inserted stack of sheets that can be retained in the folder based on the force exerted at the securement edge. This limit varies with the weight and caliper of the individual sheets that comprise the inserted stack, as well as the material utilized. For example, in a folder 10 wherein the front and back sheets 12, 14 are formed of linear polyethylene and are on the order of 0.018 or 0.023 inches thick, and the sheets 12, 14 are welded together at the securement 11, a stack comprising up to twenty sheets of conventional office bond paper is readily retained by the folder. In this embodiment, a stack thickness range of 0.007″ to 0.040″ represents a conservative range for the thickness of a retainable stack. It will be appreciated, however, that the required thickness of the front and back sheets 12, 14 of the folder 10 to retain a small stack of sheets will be dependent upon the stiffness of the material utilized, the securement 11 utilized, and the thickness of the stack of sheets wished to be retained, but it is expected that front and back sheets 12, 14 of a polymeric material on the order of 0.012 and or greater that are tightly secured together at the securement 11 will provide adequate holding force to retain a sheet or a small stack of sheets.

In summary, the invention provides a folder 10, comprising two plastic sheets 12, 14 joined along one common line of connection by a securement and open along all other edges. A small stack of sheets 34 may easily be inserted and removed from the folder because the pocket so formed between the covers is bound along only one edge. When the small stack of sheets 34 is inserted into the folder 10 between the plastic sheets 12, 14, such that the edges comprising an edge of the stack are disposed proximal to the securement edge of the folder, the stack is retained in place by the folder without the need for additional binding means or an additional sealed edge or auxiliary maintaining surface. The capacity of the folder 10 to retain the small stack 34 is due to the relatively firm nature of the sheets 12, 14, coupled with the sufficient tightness of the securement.

All references cited herein, including patents, are hereby incorporated by reference to the same extent as if each reference were individually and specifically indicated to be incorporated by reference and were set forth in its entirety herein.

The use of the terms “a,” “an” and “the” and similar referents in the context of describing the invention, especially in the context of the following claims, is to be construed to cover both the singular and the plural, unless otherwise indicated herein or clearly contradicted by context. The terms “comprising,” “having,” “including,” and “containing” are to be construed as open-ended terms (meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples or exemplary language herein (e.g., “such as”) is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations on those preferred embodiments may become apparent to those having ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A folder adapted to hold one or more sheets in a stack, said one or more sheets in said stack having a securing edge, the folder comprising a front cover sheet and a back cover sheet, the front cover sheet and the back cover sheet being adjacently disposed and each having a plurality of edges, a securement between the front cover sheet and the back cover sheet, said securement being disposed along an elongated length of the adjacently disposed front and back cover sheets, said securement and at least a portion of the edges forming a sheet receiving pocket, said portion of the edges of the front cover sheet and the back cover sheet forming the pocket being unsealed, the front cover sheet and the back cover sheet adjacent the securement being formed of a sufficiently firm and resilient material and the securement being sufficiently tight such that said one or more sheets in said stack inserted in the folder with the securing edge disposed proximal to the securement between the front and back cover sheets of the folder is retained by the folder without requiring an additional securing mechanism or securing force.

2. The folder of claim 1 wherein at least one of the front cover sheet and the back cover sheet is formed of a linear polyethylene material.

3. The folder of claim 1 wherein at least one of the front cover sheet and the back cover sheet is formed of at least one of a polypropylene material, a polystyrene material, a polyvinyl material, a polycarbonate material, and an ABS thermoplastic material.

4. The folder of claim 1 wherein the securement is a sonic weld.

5. The folder of claim 1 wherein the securement is a heat weld.

6. The folder of claim 1 wherein the securement is heat stake.

7. The folder of claim 1 wherein the securement is a heat seal.

8. The folder of claim I wherein the securement is an adhesive glue.

9. The folder of claim I wherein the securement is an adhesive tape.

10. The folder of claim I wherein at least one of the front cover and the back cover includes a transparent portion.

11. The folder of claim 1 wherein at least one of the front cover and the back cover includes a translucent portion.

12. The folder of claim 1 wherein the said one or more sheets in said stack has an aggregate thickness that is on the order of up to 0.040″.

13. The folder of claim 1 wherein the front and back cover sheets are formed of a single sheet that is folded.

14. The folder of claim 1 wherein at least one of the front or the back cover sheets comprises a locking tab, said locking tab being disposed to capture an edge of said sheet or sheets in a stack between said locking tab and said at least one of the front or back cover sheets.

15. A method of producing a folder for holding a sheet or plurality of sheets in a stack, said sheet or plurality of sheets in said stack having a securing edge, the method comprising:
producing a front cover sheet and a back cover sheet of a firm, resilient plastic material; and
securing the front cover sheet and the back cover sheet together along an elongated length by way of a securement technique to form a sheet receiving pocket bounded by the secured elongated length and a plurality of edges of the front and back cover sheets, the plurality of edges of the front and back cover sheets not being secured together, the secured elongated length being sufficiently tight and the front cover sheet and the back cover sheet being sufficiently firm and resilient such that said sheet or plurality of sheets in said stack being inserted into the sheet receiving pocket with said securing edge disposed proximal the secured elongated length is retained without requiring an additional securing force.

16. The method of claim 15 wherein the producing step comprises producing said front cover sheet and said back cover sheet from linear polyethylene.

17. The method of claim 15 wherein the producing step comprises producing said front cover sheet and said back cover sheet from at least one of polypropylene, polystyrene, polyvinyl chloride, polycarbonate, and ABS.

18. The method of claim 15 wherein the producing step comprises producing at least one of said front cover sheet and said back cover sheet with at least one of a transparent portion or a translucent portion.

19. The method of claim 15 wherein the securing step comprises the step of sonically welding the front and back cover sheets together along said elongated length.

20. The method of claim 15 wherein the securing step comprises at least one of heat welding, heat staking, heat sealing, adhesive gluing or adhesive taping the front and back cover sheets together.

21. The method of claim 15 wherein the producing step causes the front sheet and the back sheet to have sufficient firmness, and the securing step forms a sealed folder edge of sufficient tightness, so that the folder is capable of retaining a plurality of inserted sheets comprising a stack having an aggregate thickness that is on the order of up to 0.040″.

22. The method of claim 15 wherein the producing step comprising forming a locking tab in at least one of the front or back cover sheets, said locking tab being disposed to capture an edge of said sheet or sheets in a stack between said locking tab and said at least one of the front or back cover sheets.
